(19) United States
(12) Patent Application Publication
(10) Pub. No.: US 2015/0067523 A1
(43) Pub. Date: Mar. 5, 2015

(54) METHOD OF CONTROLLING MEASUREMENT WINDOW AND USER TERMINAL PERFORMING THE SAME

(71) Applicant: TEEMSTONE, Seoul (KR)

(72) Inventors: Bum Sik LEE, Seongnam-si (KR); Chang Won SEOL, Seongnam-si (KR); Ja Heon KU, Seoul (KR)

(21) Appl. No.: 14/474,440

(22) Filed: Sep. 2, 2014

(30) Foreign Application Priority Data
Sep. 2, 2013 (KR) 10-2013-0104968

(51) Int. Cl. H04L 12/26; G06F 3/0482; G01D 7/00

(52) U.S. Cl. CPC H04L 43/16; G01D 7/00; G06F 3/0482
USPC 715/736

(57) ABSTRACT

This application relates to a method of controlling a measurement window and the method includes (a) measuring measurement targets according to measurement cycles for a plurality of measurement windows, (b) displaying measurement values for the plurality of the measurement targets on a measurement target sub window of each of the plurality of the measurement windows in a time-series order, (c) detecting a temporal position of an event to provide the event when the event occurs at one of the plurality of the measurement windows, (d) detecting the temporal position for each of at least one of other measurement windows and (e) providing the event at a corresponding temporal position for each of the at least one of other measurement window. Therefore, the method may simultaneously display a system measurement value generated at a specific time on a plurality of windows.

### CROSS-REFERENCE TO RELATED APPLICATIONS

Pursuant to 35 U.S.C. §119(a), this application claims the benefit of earlier filing date and right of priority to Korean Patent Application No. 10-2013-0104968, filed on Sep. 2, 2013, the contents of which are hereby incorporated by reference herein in their entirety.

### BACKGROUND OF THE INVENTION

1. Field of the Invention

The present invention relates to a technology of controlling a measurement window and more particularly, to a method of controlling the measurement window for simultaneously displaying a system measurement value generated at a specific time on a plurality of windows.

2. Background of the Invention

Recently, a computer system performance is very rapidly improved with a development of an IT industry. A resource of the computer system is managed by an operating system. The operating system corresponds to a system software being operated as an interface between a user and a computer hardware to manage an input/output and use of a memory, a disc and a plurality of external devices and to cause a program to usefully use a hardware. The operating system manages a CPU, a memory, a file system of each of a plurality of programs to provide an environment where the program is executed.

The Korean Patent Publication No. 10-2012-0137807 relates to a graph generating system using real time stock tick data representing a price, exchange volume, contracted transaction volume and transaction time according to price variance information designated by collecting, processing and classifying the real time tick data of a stock market as a single graph. The graph generating system may easily calculate a logical statistics.

The Korean Patent Registration No. 10-1000100 relates to a used packet quantity providing method, a used packet quantity providing server, a used packet quantity displaying method, and a used packet quantity displaying terminal are provided to display the quantity of user packets in real time when a user uses a data service. The used packet quantity providing method proposes that a user checks the used packet quantity used by the user in real time to expect a packet charge being imposed.

### SUMMARY OF THE INVENTION

Example embodiments of the present invention propose a method of controlling a measurement window capable of simultaneously displaying a system measurement value generated at a specific time on a plurality of windows.

Example embodiments of the present invention propose a method of controlling a measurement window capable of equally applying a temporal position of a specific window to other windows to provide the system measurement value according to the temporal position.

Example embodiments of the present invention propose a method of controlling a measurement window capable of analyzing and managing the system usage quantity as time passed.

In some embodiments, a method of controlling a measurement window includes (a) measuring measurement targets according to measurement cycles for a plurality of measurement windows, (b) displaying measurement values for the plurality of the measurement targets on a measurement target sub window of each of the plurality of the measurement windows in a time-series order, (c) detecting a temporal position of an event to provide the event when the event occurs at one of the plurality of the measurement windows, (d) detecting the temporal position for each of at least one of other measurement windows and (e) providing the event at a corresponding temporal position for each of the at least one of other measurement window.

In one embodiment, at least some of the plurality of the measurement windows may include an attribute sub window selecting a measurement target attribute associated with the corresponding measurement window.

The step (b) may include determining a time interval of the time-series according to a size of the measurement target sub window when the measurement target attribute is selected and displaying the measurement value for the measurement target attribute on the measurement target sub window according to the time interval of the time-series.

The time interval of the time-series may be decreased when the size of the measurement target sub window is increased and may be increased when the size of the measurement target sub window is decreased.

In one embodiment, the step (a) may include determining the measurement cycles for the plurality of the measurement windows based on a measurement change value for the measurement targets according to a time.

The measurement cycle may be determined through a following [Mathematics Equation].

M_cycle=(T_range*n)/(M_{—}a1_change+M_{—}a2_change+ . . . +M_{—}an_change) [Mathematics Equation]
T_range: a specific time interval
n: a number of a measurement target attribute
M_a1_change: a measurement change value for a first measurement target attribute
M_a2_change: a measurement change value for a second measurement target attribute
M_an_change: a measurement change value for a nst measurement target attribute

In one embodiment, the measurement target may include a physical measurement target and logical measurement target. The step (c) may include displaying the temporal position of the event on one measurement target sub window of the plurality of the measurement windows with a horizontal bar and vertical bar.

The step (c) may include detecting the temporal position of another event in one of the plurality of the measurement windows when the temporal position of the event is fixed by a user.

In one embodiment, the step (e) may include displaying the corresponding temporal position of the event on each of at least one of other measurement target sub windows with the vertical bar.

The step (e) may include displaying a time value of the temporal position and the measurement value for the measurement target attribute on an extension of the vertical bar displayed on the measurement target sub window when the event is provided.

In one embodiment, the method may further include (f) representing a monitoring list including a plurality of monitoring target computers being selected by the user on a side of the measurement target sub window.

The step (f) may include indicating a display layout of the measurement value for the measurement targets on each of the plurality of the monitoring target computers.

In some embodiments, a user terminal includes a measurement target measuring unit configured to measure measurement targets according to measurement cycles for a plurality of measurement windows, a measurement value displaying unit configured to display measurement values for the measurement targets on a measurement target sub window of each of the plurality of the measurement windows in a time-series order, a super event providing unit configured to detect a temporal position of an event to provide the event when the event occurs at one of the plurality of the measurement windows, a sub temporal position detecting unit configured to detect the temporal position for each of at least one of other measurement windows and a sub event providing unit configured to provide the event at a corresponding temporal position for each of the at least one of other measurement window.

In one embodiment, the user terminal may further include a monitoring list representing unit configured to represent a monitoring list including a plurality of monitoring target computers being selected by a user on a side of the measurement target sub window.

The method of controlling a measurement window and related technologies according to an example embodiment may simultaneously display a system measurement value generated at a specific time on a plurality of windows.

The method of controlling a measurement window and related technologies according to an example embodiment may equally apply a temporal position of a specific window to other windows to provide the system measurement value according to the temporal position.

The method of controlling a measurement window and related technologies according to an example embodiment may analyze and manage the system usage quantity as time passed.

### BRIEF DESCRIPTION OF THE DRAWINGS

FIG. 1 is a block diagram illustrating a measurement window controlling server of a user terminal according to an example embodiment of the present invention.

FIG. 2 is a flow chart illustrating a procedure of controlling a measurement window being performed on the user terminal in FIG. 1.

FIG. 3 is a diagram illustrating a measurement value for a measurement target displayed according to a size of the measurement window of the user terminal in FIG. 1.

FIG. 4 is a diagram illustrating a horizontal bar and vertical bar displayed on the measurement window of the user terminal in FIG. 1.

FIG. 5 is a diagram illustrating a horizontal bar and vertical bar being displayed and fixed on the measurement window of the user terminal in FIG. 1.

FIG. 6 is a diagram illustrating a monitoring list being selected in a user terminal of FIG. 1.

### DETAILED DESCRIPTION OF THE EMBODIMENTS

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

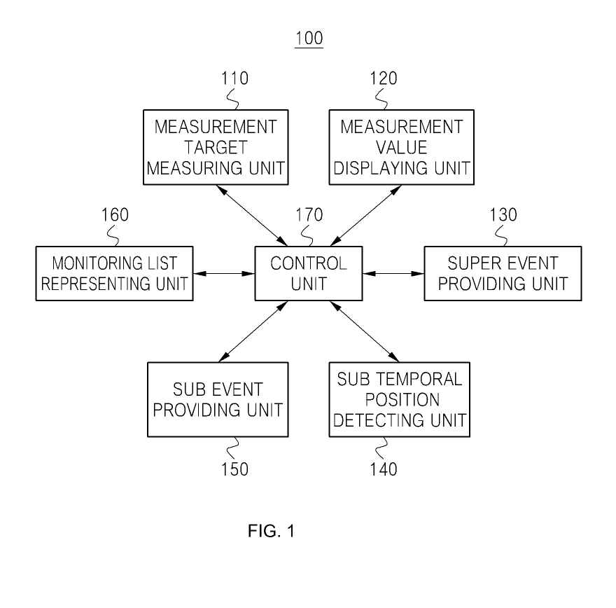

FIG. 1 is a block diagram illustrating a measurement window controlling server of a user terminal according to an example embodiment of the present invention.

Referring to FIG. 1, a user terminal 100 includes a measurement target measuring unit 110, a measurement value displaying unit 120, a super event providing unit 130, a sub temporal position detecting unit 140, a sub event providing unit 150, a monitoring list representing unit 160 and a control unit 170.

The measured target measuring unit 110 measures measurement targets according to measurement cycles for a plurality of measurement windows. The plurality of the measurement windows may include a measurement target sub window displaying a measurement value for the measurement target and an attribute sub window selecting a measurement target attribute associated with a corresponding measurement window. Herein, the measurement target sub window and the attribute sub window may cause a window size to be changed by a user.

In one embodiment, the measurement target measuring unit 110 may receive the measurement target for a specific measurement window from the user. The measurement target may include physical and logical measurement targets. For example, the physical measurement target may correspond to a hardware such as a CPU, queue, memory, kernel and input/output and the logical measurement target may correspond to a software such as a user process, system process, idle process, thread count and handle count.

The measurement target measuring unit 110 may determine a measurement cycle for the plurality of the measurement windows based on a measurement change value for the measurement targets changed by a time. Herein, the measurement change value may be calculated through the measurement value for the measurement targets changed during a specific time interval.

The measurement value displaying unit 120 displays the measurement values for the measurement targets on the measurement target sub window of each of the plurality of the measurement windows in a time-series order.

The measurement value displaying unit 120 displays the attributes and the measurement values for each of the measurement targets on the attribute sub window of each of the plurality of the measurement windows. Herein, the attribute sub window may represent the attributes in ascending order or descending order according to an attribute name or may represent the attributes in ascending order or descending order according to the measurement value.

In one embodiment, the measurement value displaying unit 120 may determine the time interval of the time-series according to a size of the measurement target sub window when the attribute of the measurement target is selected in the attribute sub window and may display the measurement value for the measurement target attribute on the measurement target sub window according to the time interval of the time-series. Herein, the time interval of the time-series may be decreased when the size of the measurement target sub window is increased and may be increased when the size of the measurement target sub window is decreased.

The measurement value displaying unit 120 may apply a specific pattern to the measurement target attribute to display the measurement value for the measurement target attribute on the measurement target sub window. For example, the specific pattern may be implemented with a color or a line type (e.g., a line or a dotted line, a line thickness).

The super event providing unit 130 detects the temporal position of the event when the event occurs at one of the plurality of the measurement windows. Herein, the event may correspond to a signal (e.g., a mouse click) being inputted through an input device (e.g., a mouse) by the user.

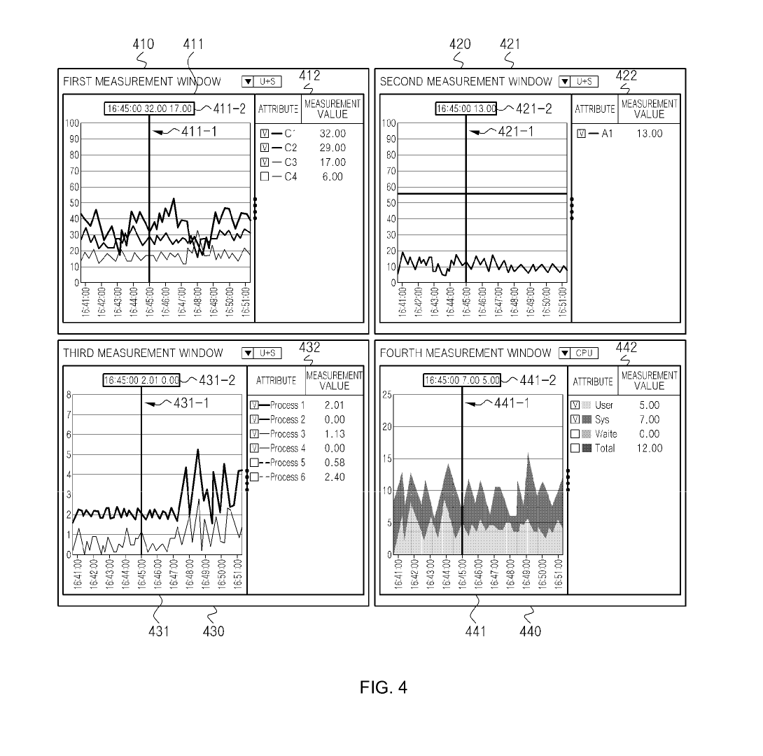

The super event providing unit 130 may display the temporal position of the event on one measurement target sub window of the plurality of the measurement windows with a horizontal bar and vertical bar. The temporal position of the event may correspond to a specific time on an axis of the time-series of the measurement target sub window. For example, in FIG. 4, the super event providing unit 130 may display the horizontal bar and vertical bar 421 at the temporal position of the event when the event occurs at the measurement target sub window 421 of a second measurement window 420. The vertical bar may be displayed at a specific time in the axis of the time-series at an occurrence time of the event and the horizontal bar may be displayed on a center of a display area where a specific measurement value on an axis of the measurement value at the occurrence time of the event or the measurement value for the measurement target in the measurement target sub window 421.

In one embodiment, the super event providing unit 130 may display a time value of the temporal position and the measurement value for the measurement target attribute on an extension of the vertical bar when the temporal position of the event is displayed with the horizontal bar and vertical bar. For example, in FIG. 4, the super event providing unit 130 may display the time value [16:45:00] of the temporal position and the measurement value [13.00] 421-2 for an attribute of the attribute sub window 422 on the extension of the vertical bar displayed on the measurement target sub window 421 of the second measurement window 420. Herein, the super event providing unit 130 may display a minimum value and maximum measurement value when the measurement value of the measurement target attribute is a plural number.

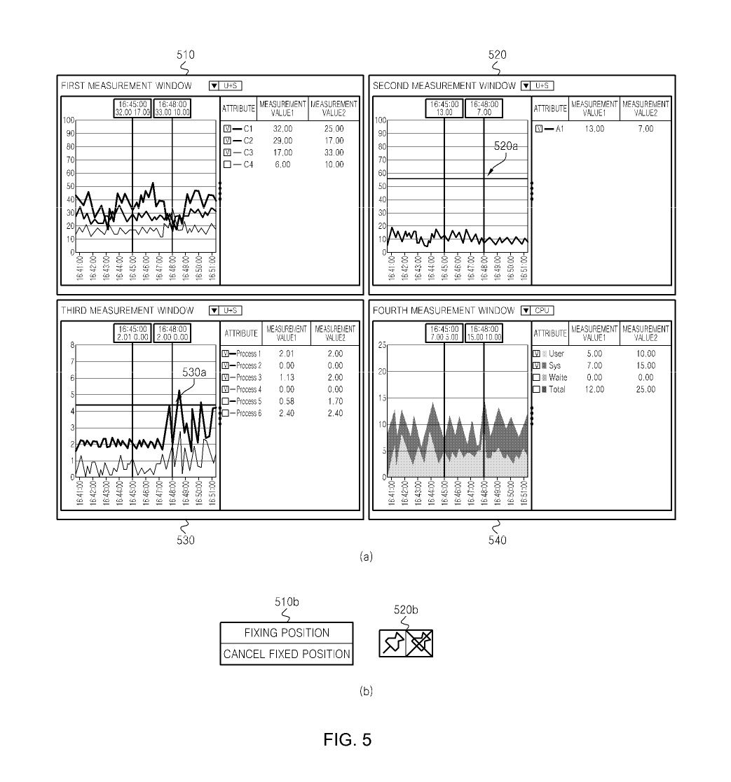

The super event providing unit 130 may detect another event in one of the plurality of the measurement windows when the temporal position of the event is fixed by the user. For example, in FIG. 5, the super event providing unit 130 may display the horizontal bar and vertical bar 520a for a first temporal position of the event generated on the second measurement window 520 and may detect a new event in a third measurement window 530 to display the horizontal bar and vertical bar 530a for the second temporal position of the new event when the first temporal position is fixed through a tap 510b and 520b adjusting whether the temporal position is fixed by the user. Herein, a number of the temporal position of the event may not be limited two and may include a plural number and the temporal position of the plurality of the events may be respectively detected in the first measurement window 510, the second measurement window 520, the third measurement window 530 and a fourth measurement window 540 or may be all detected one of the first measurement window 510, second measurement window 520, third measurement window 530 or fourth measurement window 540.

Meanwhile, the measurement value displaying unit 120 may further generate a measurement value table for the attribute of the attribute sub window according to the number of the temporal position of the event.

The sub temporal position detecting unit 140 detects the temporal position for each of at least one of other measurement windows. Herein, the at least one of other measurement windows may correspond to other measurement windows except one of the plurality of the measurement windows where the event occurs.

In one embodiment, the sub temporal position detecting unit 140 may receive the temporal position of the event occurring one of the plurality of the measurement windows from the super event providing unit 130 to detect the temporal position same with the temporal position of the event occurring on one of the plurality of the measurement windows on each of the at least one of other measurement windows.

The sub event providing unit 150 provides the event at a corresponding temporal position of each of the at least one of other measurement windows.

The sub event providing unit 150 may display the temporal position of the event on at least one of other measurement target sub windows with the vertical bar. Herein, the temporal position may correspond to a specific time on the axis of the time-series in the at least one of other measurement target sub windows same with the temporal position of the event occurring on one of the plurality of the measurement windows. For example, in FIG. 4, the sub event providing unit 150 may display the vertical bar 411-1, 431-1 and 441-1 on the temporal position of the event in the measurement target sub window 411 of the first measurement window 410, the measurement target sub window 431 of the third measurement window 430 and the measurement target sub window 441 of the fourth measurement window 440 when the event occurs at the measurement target sub window 421 of the second measurement window 420. The vertical bar may be displayed at the specific time on the axis of the time-series at the occurrence time of the event.

In one embodiment, the sub event providing unit 150 may display the time value of the temporal position and the measurement value for the measurement target attribute on the extension of the vertical bar when the temporal position of the event is displayed with the vertical bar. For example, in FIG. 4, the super event providing unit 130 may display the time value [16:45:00] of the temporal position and the measurement value [32.00 17.00] 411-2 for the attribute of the attribute sub window 412 on the extension of the vertical bar displayed on the measurement target sub window 411 of the first measurement window 410, may display the time value [16:45:00] of the temporal position and the measurement value [2.01 0.00] 431-2 for the attribute of the attribute sub window 432 on the extension of the vertical bar displayed on the measurement target sub window 431 of the third measurement window 430 and may display the time value [16:45:00] of the temporal position and the measurement value [7.00 5.00] 441-2 for the attribute of the attribute sub window 442 on the extension of the vertical bar displayed on the measurement target sub window 441 of the fourth measurement window 440. Herein, the sub event providing unit 150 may display the minimum value and maximum measurement value when the measurement value of the measurement target attribute is a plural number.

The monitoring list representing unit 160 represents a monitoring list including a plurality of monitoring target computers being selected by the user on a side of the measurement target sub window. Herein, the user terminal 100 may monitor the measurement value for the measurement targets of the plurality of the measurement windows for the plurality of the monitoring target computers.

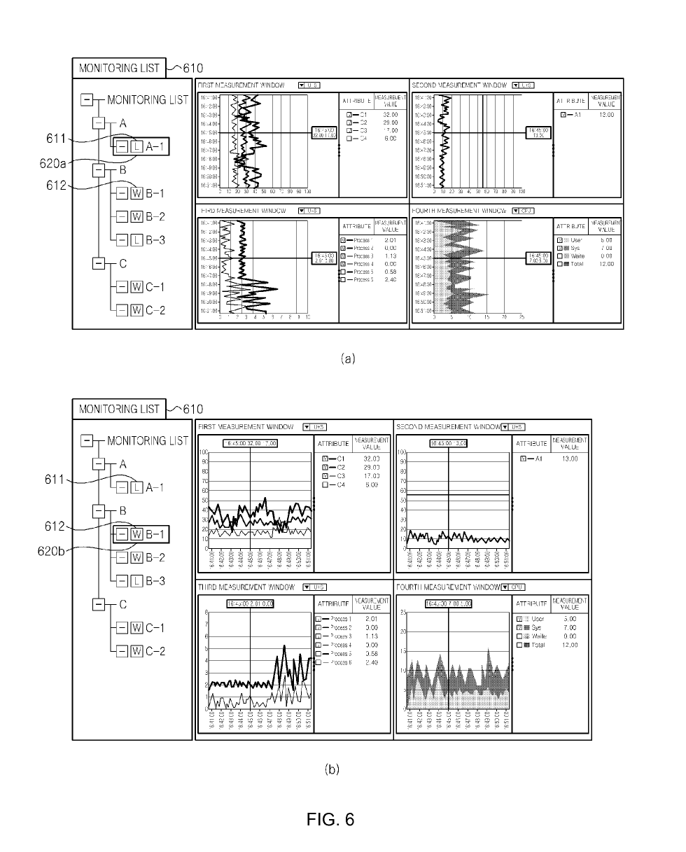

In one embodiment, the monitoring list representing unit 160 may represent the measurement value for the measurement targets of the plurality of the measurement windows for a specific monitoring target computer when the specific monitoring target computer is selected in the plurality of the monitoring target computers. For example, in FIG. 6(a), the monitoring list representing unit 160 may represent the measurement value for the measurement targets of the plurality of the measurement windows measured in an A-1 monitoring target computer 620a when the A-1 monitoring target computer 620a is selected by the user in the monitoring list. For another example, in FIG. 6(b), the monitoring list representing unit 160 may represent the measurement value for the measurement targets of the plurality of the measurement windows measured for an B-1 monitoring target computer 620b when the B-1 monitoring target computer 620b is selected by the user in the monitoring list.

The monitoring list representing unit 160 may indicate a display layout of the measurement value for each of the plurality of the monitoring target computers. For example, FIG. 6(a) is an example diagram illustrating a horizontal display layout of the measurement value for the measurement target measured for the monitoring target computer and FIG. 6(b) is an example diagram illustrating a vertical display layout of the measurement value for the measurement target measured for the monitoring target computer.

The control unit 170 controls overall operation of a window control server in the user terminal 100 and a control flow or data flow between the measurement target measuring unit 110, the measurement value displaying unit 120, the super event providing unit 130, the sub temporal position detecting unit 140, the sub event providing unit 150 and the monitoring list representing unit 160.

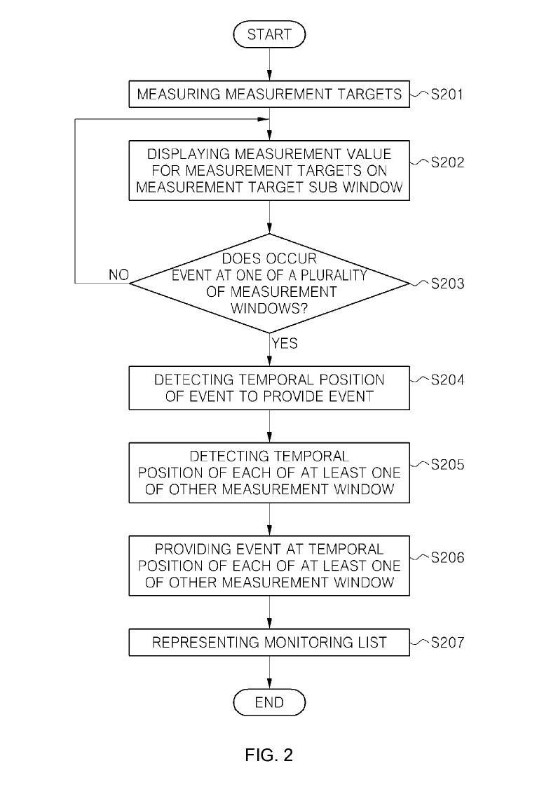

FIG. 2 is a flow chart illustrating a procedure of controlling a measurement server being performed on the user terminal in FIG. 1.

Referring to FIG. 2, the measurement target measuring unit 110 measures the measurement targets according to the measurement cycles for a plurality of measurement windows (Step S201). The plurality of the measurement windows may include the measurement target sub window displaying the measurement value for the measurement targets and the attribute sub window selecting the measurement target attribute associated with the corresponding measurement window.

The measurement target measuring unit 110 may determine the measurement cycle for the plurality of the measurement windows based on the measurement change value for the measurement targets changed by the time. Herein, the measurement change value may be calculated through the measurement value for the measurement targets changed during a specific time interval.

In one embodiment, the measurement cycle may be determined through a following [Mathematics Equation].

M_cycle=(T_range*n)/(M_{—}a1_change+M_{—}a2_change+ . . . +M_{—}an_change) [Mathematics Equation]

Herein, the M_a1_change may correspond to a measurement change value for a first measurement target attribute, the M_a2_change may correspond to the measurement change value for a second measurement target attribute, the M_an_change may correspond to the measurement change value for a nst measurement target attribute, the T_range may correspond to a specific time interval and the n may correspond to a number of a measurement target attribute. For example, when the number of the measurement target attribute is 4, the measurement change value for the first measurement target attribute measured for 30 s (i.e., the specific time interval) is 20.0, the measurement change value for the second measurement target attribute measured for 30 s (i.e., the specific time interval) is 21.2, the measurement change value for the third measurement target attribute measured for 30 s (i.e., the specific time interval) is 33.8 and the measurement change value for the fourth measurement target attribute measured for 30 s (i.e., the specific time interval) is 14.0, the measurement cycle may be determined on 1.3 sec

$$( \frac{( 30 \times 4 )}{( 20 + 21.2 + 33.8 + 15.0 )} ) .$$

For another example, when the number of the measurement target attribute is 4, the measurement change value for the first measurement target attribute measured for 30 s (i.e., the specific time interval) is 30.0, the measurement change value for the second measurement target attribute measured for 30 s (i.e., the specific time interval) is 25.5, the measurement change value for the third measurement target attribute measured for 30 s (i.e., the specific time interval) is 50.3 and the measurement change value for the fourth measurement target attribute measured for 30 s (i.e., the specific time interval) is 44.2, the measurement cycle may be determined on 0.8 sec

$$( \frac{( 30 \times 4 )}{( 30.0 + 25.5 + 50.3 + 44.2 )} ) .$$

Therefore, the measurement cycle may be inversely proportional to the measurement change value for the measurement target attribute.

The measurement value displaying unit 120 displays the measurement values for the measurement targets on the measurement target sub window of each of the plurality of the measurement windows in a time-series order (Step S202).

The measurement value displaying unit 120 may apply the specific pattern to the measurement target attribute to display the measurement value for the measurement target attribute on the measurement target sub window. For example, the specific pattern may be implemented with a color or a line type (e.g., a line or a dotted line, a line thickness).

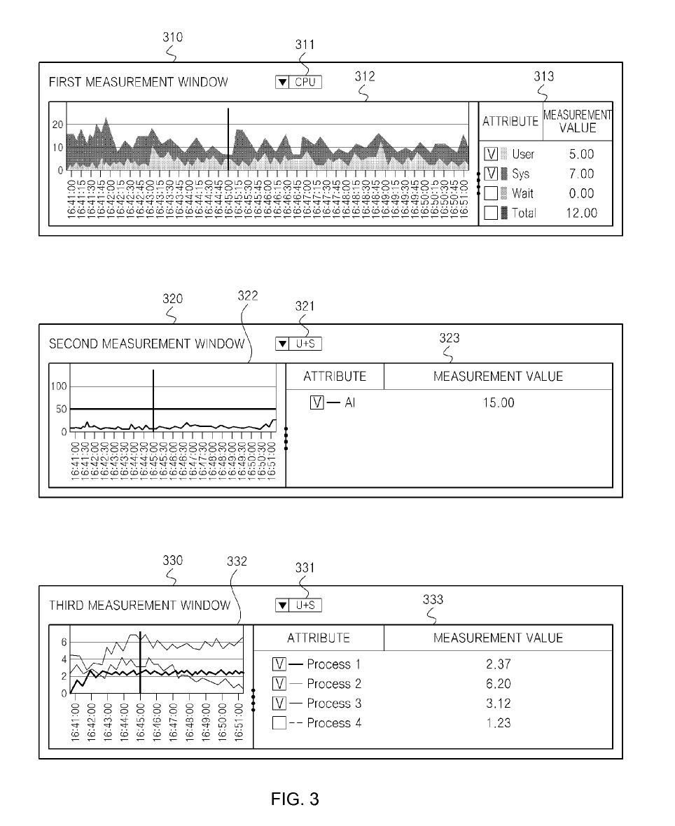

In FIG. 3, the measurement value displaying unit 120 may represent the measurement target attributes (e.g., a User, Sys, Wait and Total) on the attribute sub window 313 to receive at least one attribute (e.g., the User or Sys) through a multi-check box when the measurement target 311 of the first measurement window 310 is selected through a combo box, may represent the measurement target attribute (e.g., A1) on the attribute sub window 323 to receive at least one attribute (e.g., the A1) through the multi-check box when the measurement target 321 of the second measurement window 320 is selected through the combo box and may represent the measurement target attributes (e.g., a Process1, Process2, Process3 and Process4) on the attribute sub window 333 to receive the at least one attribute (e.g., the Process1, Process2 or Process3) through the multi-check box when the measurement target 331 of the third measurement window 330 is selected through the combo box.

The measurement value displaying unit 120 may determine the time interval of the time-series on 00:00:15 according to the size of the measurement target sub window 312 of the first measurement window 310, may determine the time interval of the time-series on 00:00:30 according to the size of the measurement target sub window 322 of the second measurement window 320 and may determine the time interval of the time-series on 00:01:00 according to the size of the measurement target sub window 332 of the first measurement window 330. Herein, an interval between a start time and a finish time of the time-series may be set by the user and FIG. 3 is example diagram where the interval is set with 10 minutes.

The measurement value displaying unit 120 may display the measurement value for the measurement target attribute (e.g., the User or Sys) on the measurement target sub window 312 according to the time interval of the time-series 00:00:15 for the first measurement window 310, may display the measurement value for the measurement target attribute (e.g., the A1) on the measurement target sub window 322 according to the time interval of the time-series 00:00:30 for the second measurement window 320 and may display the measurement value for the measurement target attribute (e.g., the Process1, Process2 or Process3) on the measurement target sub window 332 according to the time interval of the time-series 00:01:00 for the third measurement window 330.

Hereinafter, FIG. 2 is described.

The super event providing unit 130 detects the temporal position of the event to provide the event when the event occurs at one of the plurality of the measurement windows (Steps S203 and S204).

The super event providing unit 130 may detect another event in one of the plurality of the measurement windows when the temporal position of the event is fixed by the user. For example, the super event providing unit 130 may display the horizontal bar and vertical bar 520a for the first temporal position of the event generated on the second measurement window 520 and may detect the new event in the third measurement window 530 to display the horizontal bar and vertical bar 530a for the second temporal position of the new event when the first temporal position is fixed through the tap 510b and 520b adjusting whether the temporal position is fixed by the user. Herein, the number of the temporal position of the event may not be limited two and may include the plural number and the temporal position of the plurality of the events may be respectively detected in the first measurement window 510, the second measurement window 520, the third measurement window 530 and the fourth measurement window 540 or may be all detected one of the first measurement window 510, second measurement window 520, third measurement window 530 or fourth measurement window 540.

The sub temporal position detecting unit 140 detects the temporal position for each of the at least one of other measurement windows (Step S205). Herein, the at least one of other measurement windows may correspond to other measurement windows except one of the plurality of the measurement windows where the event occurs.

The sub temporal position detecting unit 140 provides the event at the corresponding temporal position of each of the at least one of other measurement windows (Step S206).

The sub event providing unit 150 may display the temporal position of the event on the at least one of other measurement target sub windows with the vertical bar. Herein, the temporal position may correspond to the specific time on the axis of the time-series in the at least one of other measurement target sub windows same with the temporal position of the event occurring on one of the plurality of the measurement windows.

In one embodiment, the sub event providing unit 150 may display the time value of the temporal position and the measurement value for the measurement target attribute on the extension of the vertical bar when the temporal position of the event is displayed with the vertical bar.

The monitoring list representing unit 160 represents the monitoring list including the plurality of the monitoring target computers being selected by the user on the side of the measurement target sub window (Step S207). Herein, a procedure of representing the monitoring list being performed on the monitoring list representing unit 160 may not be limited at Step S207 and may be performed at may be performed at one of before or after Step S201, Step S202, Step S203, Step S204, Step S205 and Step S206.

The monitoring list representing unit 160 may indicate the display layout of the measurement value for each of the plurality of the monitoring target computers. For example, in FIG. 6, the monitoring list representing unit 160 may indicate L 611 signifying the horizontal display layout in A-1 monitoring target computer and B-3 monitoring target computer and may indicate W 612 signifying the vertical display layout in B-1 monitoring target computer, B-2 monitoring target computer, C-1 monitoring target computer and C-2 monitoring target computer. Herein, the horizontal display layout and vertical display layout of the measurement value for the measurement target may be set by the user. FIG. 6(a) is an example diagram illustrating the horizontal display layout of the measurement value for the measurement target measured for the monitoring target computer and FIG. 6(b) is an example diagram illustrating a vertical display layout of the measurement value for the measurement target measured for the monitoring target computer.

Although this document provides descriptions of preferred embodiments of the present invention, it would be understood by those skilled in the art that the present invention can be modified or changed in various ways without departing from the technical principles and scope defined by the appended claims.

### DESCRIPTION OF SYMBOLS

100: USER TERMINAL
110: MEASUREMENT TARGET MEASURING UNIT
120: MEASUREMENT VALUE DISPLAYING UNIT
130: SUPER EVENT PROVIDING UNIT
140: SUB TEMPORAL POSITION DETECTING UNIT
150: SUB EVENT PROVIDING UNIT
160: MONITORING LIST REPRESENTING UNIT
170: CONTROL UNIT

What is claimed is:

1. A method of controlling a measurement window, the method comprising:
(a) measuring measurement targets according to measurement cycles for a plurality of measurement windows;
(b) displaying measurement values for the plurality of the measurement targets on a measurement target sub window of each of the plurality of the measurement windows in a time-series order;
(c) detecting a temporal position of an event to provide the event when the event occurs at one of the plurality of the measurement windows;
(d) detecting the temporal position for each of at least one of other measurement windows; and
(e) providing the event at a corresponding temporal position for each of the at least one of other measurement window.

2. The method of claim 1, wherein at least some of the plurality of the measurement windows includes
an attribute sub window selecting a measurement target attribute associated with the corresponding measurement window.

3. The method of claim 2, wherein the step (b) includes
determining a time interval of the time-series according to a size of the measurement target sub window when the measurement target attribute is selected; and
displaying the measurement value for the measurement target attribute on the measurement target sub window according to the time interval of the time-series.

4. The method of claim 3, wherein the time interval of the time-series is decreased when the size of the measurement target sub window is increased and is increased when the size of the measurement target sub window is decreased.

5. The method of claim 1, wherein the step (a) includes
determining the measurement cycles for the plurality of the measurement windows based on a measurement change value for the measurement targets according to a time.

6. The method of claim 5, wherein the measurement cycle is determined through a following [Mathematics Equation].
M_cycle=(T_range*n)/(M_{—}a1_change+M_{—}a2_change+ . . . +M_{—}an_change) [Mathematics Equation]
T_range: a specific time interval
n: a number of a measurement target attribute
M_a1_change: a measurement change value for a first measurement target attribute
M_a2_change: a measurement change value for a second measurement target attribute
M_an_change: a measurement change value for a nst measurement target attribute

7. The method of claim 1, wherein the measurement target includes a physical measurement target and logical measurement target.

8. The method of claim 1, wherein the step (c) includes
displaying the temporal position of the event on one measurement target sub window of the plurality of the measurement windows with a horizontal bar and vertical bar.

9. The method of claim 1, wherein the step (c) includes
detecting the temporal position of another event in one of the plurality of the measurement windows when the temporal position of the event is fixed by a user.

10. The method of claim 8, wherein the step (e) includes
displaying the corresponding temporal position of the event on each of at least one of other measurement target sub windows with the vertical bar.

11. The method of claim 10, wherein the step (e) includes
displaying a time value of the temporal position and the measurement value for the measurement target attribute on an extension of the vertical bar displayed on the measurement target sub window when the event is provided.

12. The method of claim 1, further comprising:
(f) representing a monitoring list including a plurality of monitoring target computers being selected by the user on a side of the measurement target sub window.

13. The method of claim 12, wherein the step (f) includes
indicating a display layout of the measurement value for the measurement targets on each of the plurality of the monitoring target computers.

14. A user terminal comprising:
a measurement target measuring unit configured to measure measurement targets according to measurement cycles for a plurality of measurement windows;
a measurement value displaying unit configured to display measurement values for the measurement targets on a measurement target sub window of each of the plurality of the measurement windows in a time-series order;
a super event providing unit configured to detect a temporal position of an event to provide the event when the event occurs at one of the plurality of the measurement windows;
a sub temporal position detecting unit configured to detect the temporal position for each of at least one of other measurement windows; and
a sub event providing unit configured to provide the event at a corresponding temporal position for each of the at least one of other measurement window.

15. The user terminal of claim 14, further comprising:
a monitoring list representing unit configured to represent a monitoring list including a plurality of monitoring target computers being selected by a user on a side of the measurement target sub window.
